(19) United States
(12) Patent Application Publication
(10) Pub. No.: US 2026/0008580 A1
(43) Pub. Date: Jan. 8, 2026

(54) Medication Container with Enhanced Stability and Label Visibility

(71) Applicant: Alirea Khosrowpour, Hillsdale (CA)

(72) Inventor: Alirea Khosrowpour, Hillsdale (CA)

(21) Appl. No.: 18/765,578

(22) Filed: Jul. 8, 2024

(51) Int. Cl. B65D 1/02; A61J 1/05; B65D 23/08; B65D 41/34; B65D 50/00; B65D 65/42

(52) U.S. Cl. CPC B65D 1/0284; B65D 1/0207; B65D 23/0807; B65D 41/34; B65D 50/00; B65D 65/42; A61J 1/05; B65D 2203/02; B65D 2501/0081

(57) ABSTRACT

A container for storing medications comprises a body with a top end, a bottom end, and a closeable opening at the top end. The bottom end features a stabilizing structure with a pair of projections positioned on opposite sides of the body and a connecting portion between the projections. The body includes a substantially planar first surface extending from the top end to the connecting portion, a pair of second surfaces extending from the top end to the sides of the projections, and a third surface with an upper portion protruding outward, a middle portion tapering inward, and a lower portion forming part of the stabilizing structure. This design enhances stability, label visibility, and ease of handling. The closeable opening can include various mechanisms such as a screw cap, child-resistant cap, snap-fit cap, flip-top cap, press-and-turn cap, or hermetically sealed cap to ensure airtight storage.

### FIELD OF INVENTION

The present invention relates generally to the field of medication storage containers. Specifically, it concerns an ergonomically designed container that enhances stability, label visibility, and ease of handling.

### BACKGROUND

The storage and handling of medications present critical challenges in both domestic and clinical environments. Traditional containers for medications often fail to address key aspects such as stability, visibility, and ease of handling, resulting in significant drawbacks for users and impacting medication compliance and safety.

Conventional medication vials are typically cylindrical in shape. While this design is simple and cost-effective, it introduces several practical issues. One of the primary concerns is the instability of cylindrical vials. When placed on a flat surface, these vials can easily roll away if accidentally knocked over. This rolling can lead to the vial falling off surfaces and breaking, resulting in the loss of medication, potential contamination, and the risk of injury from broken glass. Moreover, a rolling vial can be difficult to locate if it ends up in an inaccessible area, causing inconvenience and possible missed doses for the patient.

Another significant limitation of traditional cylindrical vials is the restricted surface area for labeling. Medication labels are essential for conveying critical information such as dosage instructions, warnings, ingredients, and expiration dates. The curved surface of cylindrical vials limits the size and format of labels that can be applied, often resulting in small font sizes and overcrowded text. This lack of space can make the labels difficult to read, particularly for individuals with visual impairments or those who struggle with small print. Poor readability increases the risk of medication errors, such as incorrect dosage or missed precautions, which can have serious health implications.

In addition to stability and labeling challenges, the ergonomic design of traditional medication vials leaves much to be desired. The smooth, cylindrical shape does not provide an easy grip, especially for individuals with limited hand strength, dexterity issues, or arthritis. Opening and handling these vials can be particularly challenging for elderly patients or those with disabilities, leading to frustration and potential non-compliance with medication regimens. The lack of ergonomic consideration in the design of these containers thus poses a barrier to effective medication management.

Furthermore, traditional vials often have simple screw caps that can be difficult to open, especially for individuals with limited dexterity. This can lead to patients resorting to unsafe methods to open the vial, such as using sharp objects, which increases the risk of injury. In some cases, patients may not be able to open the vial at all, leading to missed doses and compromised treatment efficacy.

The limitations of traditional medication vials highlight the need for a redesigned container that addresses these critical issues. A vial that offers enhanced stability, improved labeling space, and ergonomic handling would significantly benefit patients. Such a design would help prevent medication loss and contamination, improve the readability of labels, and make it easier for patients to manage their medication regimen effectively. By addressing these shortcomings, the overall safety, accessibility, and convenience of medication containers can be greatly improved, leading to better health outcomes and increased patient compliance.

It is within this context that the present invention is provided.

### SUMMARY

The present invention relates to a container for storing medications, comprising a body with a top end, a bottom end, a closeable opening at the top end, and a stabilizing structure at the bottom end. The stabilizing structure includes a pair of projections positioned on opposite sides of the body, with a connecting portion located between the projections. The body has a first surface that is substantially planar, a pair of second surfaces extending from the top end to the sides of the projections, and a third surface with an upper portion that protrudes outward, a middle portion that tapers inward, and a lower portion forming part of the stabilizing structure. The design enhances stability, label visibility, and ease of handling.

In some embodiments, the stabilizing structure comprises a pair of elongated feet positioned on opposite sides of the body, providing enhanced stability when placed on a surface.

In further embodiments, the connecting portion is rounded and spans between the elongated feet, facilitating stability and resistance to breaking.

In yet further embodiments, the first surface is planar and extends continuously from the top end to the connecting portion at the bottom end, and is adapted to accommodate a label, allowing for clear and legible display of medication information.

In some embodiments, the first surface is sized to accommodate a label with larger fonts for improved legibility, and is further configured to include a writable area for additional user information, enhancing the accessibility of important details.

In further embodiments, the pair of second surfaces are planar and extend continuously from the top end to the sides of the projections, contributing to the overall structural integrity of the container.

In yet further embodiments, the third surface includes an upper portion that protrudes outward to conform to the user's grip, a middle portion that tapers inward towards the bottom end, and a lower portion that forms the tips of the projections, facilitating ergonomic handling.

In some embodiments, the closeable opening comprises a screw cap mechanism, which can be replaced with alternative mechanisms such as a child-resistant cap, a snap-fit cap, a flip-top cap, a press-and-turn cap, or a hermetically sealed cap to ensure airtight storage, offering flexibility in securing the contents

In further embodiments, the body has a generally rectangular profile in cross-section, providing a stable and compact design.

In yet further embodiments, the container body is configured to allow the container to stand stably on any of its surfaces, preventing rolling and potential spillage.

In some embodiments, the body is constructed from materials such as polyethylene, polypropylene, polyvinyl chloride, polystyrene, glass, or composite materials, ensuring durability and resistance to breaking.

In further embodiments, the projections at the bottom end are coated with a non-slip material to enhance stability on smooth surfaces.

In yet further embodiments, the body is transparent or translucent to allow visual inspection of the contents, or opaque to protect the contents from light exposure, offering options for different storage needs.

In some embodiments, the container further comprises an anti-tamper seal integrated with the closeable opening, providing added security.

In further embodiments, the body includes measurement markings to indicate the volume of the contents, aiding in precise dosage measurement.

In yet further embodiments, the body includes a grip-enhancing texture or coating on at least a portion of the surfaces, improving the ease of handling.

### BRIEF DESCRIPTION OF THE DRAWINGS

Various embodiments of the invention are disclosed in the following detailed description and accompanying drawings.

FIG. 1A illustrates an example rear view of the container

FIG. 1B illustrates an example side view of the container.

FIG. 1C illustrates an example perspective top-down view of the container.

FIG. 1D illustrates an example perspective bottom-up view of the container.

FIG. 2 illustrates an example cross-sectional side view of the container.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “container” refers to any receptacle or enclosure used for storing medications. This includes, but is not limited to, bottles, vials, and canisters designed to hold solid, liquid, or semi-solid pharmaceutical substances. In one example implementation, the container may be a vial made of polyethylene, shaped with a rectangular profile for enhanced stability.

The term “body” refers to the main structural component of the container, extending from the top end to the bottom end. This includes, but is not limited to, the portion of the container that encloses the medication. In one example implementation, the body is constructed from transparent polypropylene, allowing visual inspection of the contents.

The term “stabilizing structure” refers to any feature or component at the bottom end of the container that enhances its stability when placed on a surface. This includes, but is not limited to, projections, feet, or other extensions. In one example implementation, the stabilizing structure comprises a pair of elongated feet positioned on opposite sides of the body, providing a broad base for stability.

The term “closeable opening” refers to any mechanism or feature at the top end of the container that allows for secure opening and closing. This includes, but is not limited to, screw caps, snap-fit caps, flip-top caps, press-and-turn caps, and hermetically sealed caps. In one example implementation, the closeable opening is a child-resistant cap designed to prevent accidental access by children.

The term “projections” refers to any extensions or feet located at the bottom end of the container, positioned on opposite sides to provide stability. This includes, but is not limited to, any structural components that prevent the container from rolling. In one example implementation, the projections are integrally molded with the container body and coated with a non-slip material.

The term “connecting portion” refers to the segment located between the projections at the bottom end of the container. This includes, but is not limited to, a rounded or planar portion that enhances the structural integrity and stability of the container. In one example implementation, the connecting portion is rounded to facilitate stability and resistance to breaking.

Suitable materials for the construction of the container body include, but are not limited to, polyethylene, polypropylene, polyvinyl chloride, polystyrene, glass, and composite materials. These materials provide durability, transparency or opacity as needed, and resistance to breaking. The container may also include additional features such as measurement markings for precise dosage, integrated desiccant holders to maintain the integrity of the medication, and anti-tamper seals for security.

### DESCRIPTION OF DRAWINGS

The present invention relates to a container for storing medications that addresses the shortcomings of traditional medication vials. Conventional containers often suffer from issues such as instability, limited label visibility, and poor ergonomic design, which can lead to medication errors, spillage, and difficulty in handling. The invention disclosed herein offers a solution to these problems through a novel container design that enhances stability, label visibility, and ease of handling.

The container comprises a body with a top end and a bottom end. The top end includes a closeable opening, which can be secured using various mechanisms such as screw caps, snap-fit caps, flip-top caps, press-and-turn caps, or hermetically sealed caps, providing flexibility in securing the contents. The bottom end features a stabilizing structure that includes a pair of projections positioned on opposite sides of the body, and a connecting portion between the projections, enhancing the container's stability and resistance to breaking.

One of the primary advantages of the invention is its stabilizing structure. The projections, or feet, prevent the container from rolling when placed on a surface, thus reducing the risk of spillage and breakage. The rounded connecting portion further enhances stability by providing a sturdy base that can withstand impacts.

The body of the container includes a first surface that is substantially planar, extending from the top end to the connecting portion at the bottom end. This planar surface is designed to accommodate larger labels, which can display medication information more clearly and legibly. Additionally, the first surface can include a writable area for additional user information, further enhancing the accessibility of critical details.

The container also features a pair of second surfaces extending from the top end to the sides of the projections. These planar side surfaces contribute to the structural integrity of the container and provide additional space for handling.

A third surface of the container extends from the top end to the connecting portion at the bottom end, comprising an upper portion that protrudes outward, a middle portion that tapers inward, and a lower portion forming part of the stabilizing structure. This design facilitates an ergonomic grip, making it easier for users, especially those with limited dexterity, to handle and open the container.

The container body can be constructed from a variety of materials, including polyethylene, polypropylene, polyvinyl chloride, polystyrene, glass, and composite materials, ensuring durability and resistance to breaking. The projections at the bottom end can be coated with a non-slip material to enhance stability on smooth surfaces.

Additional features such as measurement markings for precise dosage, integrated desiccant holders to maintain the integrity of the medication, and anti-tamper seals for security further enhance the functionality and safety of the container.

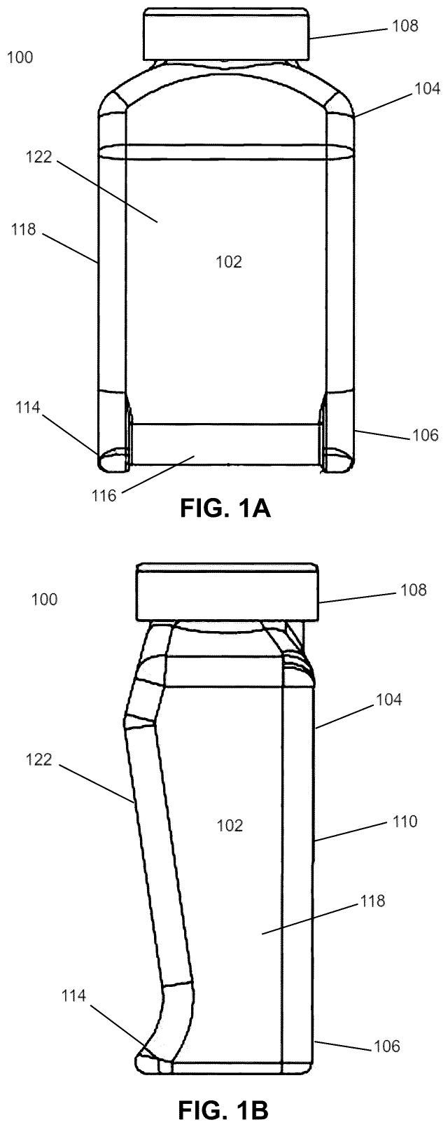

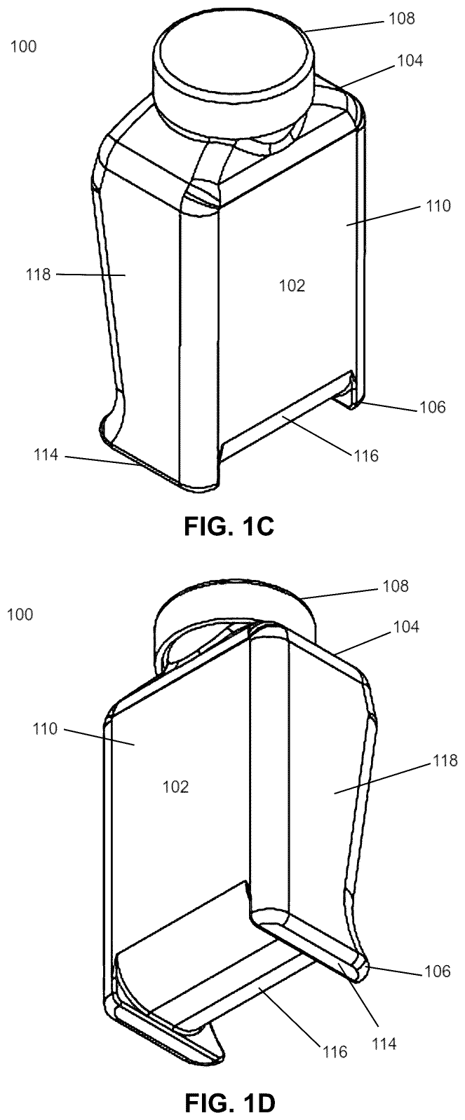

Referring now to the drawings, FIGS. 1A to 1D show various views of an example configuration of the container.

FIG. 1A and FIG. 1B illustrate, respectively, a rear view and side view of an example implementation of the container 100. The container 100 comprises a body 102 with a top end 104 and a bottom end 106. The top end 104 includes a closeable opening covered by a screw cap 108. The bottom end 106 features a stabilizing structure with a pair of projections 114 positioned on opposite sides of the body 102, and a rounded connecting portion 116 located between the projections 114 to enhance stability and resistance to breaking.

The front surface 110 of the body 102 extends from the top end 104 to the bottom end 106 and is substantially planar, providing an area for accommodating labels. The body 102 includes a pair of planar side surfaces 118 extending from the top end 104 to the sides of the projections 114.

The rear view highlights the third surface 120, which comprises an upper portion that protrudes outward, a middle portion that tapers inward towards the bottom end 106, and a lower portion that transitions to form part of the stabilizing structure. The ergonomic design of the third surface 120 facilitates an easier and more secure grip for the user.

FIG. 1C illustrates a perspective top-down view of the front of the container 100, providing a clear view of the top end 104 with the closeable opening covered by the screw cap 108. The planar front surface 110 and the pair of planar side surfaces 118 are visible from this perspective, demonstrating the container's rectangular profile. The projections 114 at the bottom end 106 are also partially visible, indicating the stabilizing structure that prevents the container 100 from rolling and enhances stability when placed on a surface.

FIG. 1D illustrates a perspective bottom-up view of the container 100, showing the detailed structure of the bottom end 106. The stabilizing structure with the pair of projections 114 positioned on opposite sides of the body 102 is clearly visible. The rounded connecting portion 116 between the projections 114 is shown to facilitate stability and resistance to breaking. This view also highlights the lower portion of the third surface 120, which forms part of the stabilizing structure, enhancing the overall stability and durability of the container 100.

In all the figures, the body 102 can be constructed from materials such as polyethylene, polypropylene, polyvinyl chloride, polystyrene, glass, or composite materials. The planar front surface 110 is adapted to accommodate labels with larger fonts for improved legibility and can include a writable area for additional user information. The screw cap 108 at the top end 104 can be replaced with alternative mechanisms such as a snap-fit cap, flip-top cap, press-and-turn cap, or hermetically sealed cap to ensure airtight storage. The projections 114 can be coated with a non-slip material to enhance stability on smooth surfaces, and the body 102 may include measurement markings to indicate the volume of the contents.

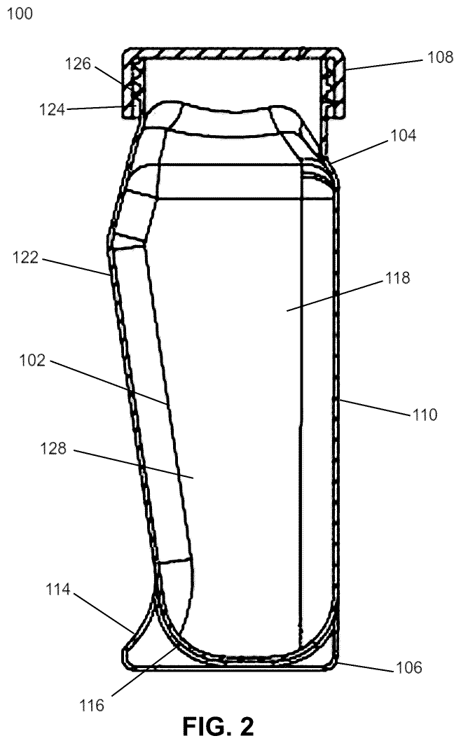

FIG. 2 illustrates a cross-sectional side view of the container 100, providing an internal perspective of its structure. The body 102 extends from the top end 104 to the bottom end 106. The top end 104 includes a closeable opening covered by a screw cap 108, which engages with the threaded neck 128 of the container 100 to form a secure closure.

The interior of the body 102 is hollow, allowing for the storage of medications. The third surface 120 is visible in this cross-sectional view, comprising the upper portion that protrudes outward, the middle portion that tapers inward towards the bottom end 106, and the lower portion forming part of the stabilizing structure, enhancing the ergonomic handling of the container 100.

The projections 114 at the bottom end 106 provide stability, and the rounded connecting portion 116 spans between these projections 114, enhancing the structural integrity and resistance to breaking. The screw cap 108 includes an inner sealing ring 124 that engages with the neck 126 of the container 100 to ensure an airtight seal, preventing the contents from being exposed to external contaminants and maintaining the integrity of the stored medication.

This cross-sectional view underscores the importance of the choice of materials for constructing the body 102, such as polyethylene, polypropylene, polyvinyl chloride, polystyrene, glass, or composite materials, ensuring durability and resistance to breaking. The internal hollow space 128 is designed to hold the medication securely, and additional features such as integrated desiccant holders or anti-tamper seals can be included to further enhance the functionality and safety of the container 100.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the container of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A container for storing medications, comprising:
a. a body having a top end and a bottom end;
b. a closeable opening disposed at the top end;
c. a stabilizing structure located at the bottom end, wherein the stabilizing structure includes a pair of projections positioned on opposite sides of the body;
d. a connecting portion located between the projections at the bottom end;
e. a first surface of the body extending between the top end and the connecting portion at the bottom end, the first surface being substantially planar;
f. a pair of second surfaces extending from the top end to the sides of the projections;
g. a third surface of the body extending from the top end to the connecting portion at the bottom end, wherein the third surface comprises:
i. an upper portion that protrudes outward;
ii. a middle portion that tapers inward towards the bottom end; and
iii. a lower portion at the bottom end forming part of the stabilizing structure.

2. The container of claim 1, wherein the stabilizing structure comprises a pair of elongated feet positioned on opposite sides of the body.

3. The container of claim 2, wherein the connecting portion is rounded and spans between the elongated feet, and is rounded to facilitate stability and resistance to breaking.

4. The container of claim 1, wherein the first surface is planar and extends continuously from the top end to the connecting portion at the bottom end, and is adapted to accommodate a label.

5. The container of claim 4, wherein the first surface is sized to accommodate a label with larger fonts for improved legibility, and further configured to include a writable area for additional user information.

6. The container of claim 1, wherein the pair of second surfaces are planar and extend continuously from the top end to the sides of the projections.

7. The container of claim 1, wherein the third surface further comprises:
a. an upper portion that protrudes outward to conform to the user's grip;
b. a middle portion that tapers inward towards the bottom end; and
c. a lower portion that forms the tips of the projections.

8. The container of claim 1, wherein the closeable opening comprises a screw cap mechanism.

9. The container of claim 8, wherein the closeable opening comprises a child-resistant cap mechanism.

10. The container of claim 1, wherein the body has a generally rectangular profile in cross-section.

11. The container of claim 1, wherein the container body is configured to allow the container to stand stably on any of its surfaces.

12. The container of claim 1, wherein the bottom end includes a portion that is rounded to facilitate stability and resistance to breaking.

13. The container of claim 1, wherein the body is constructed from a plastic material selected from the group consisting of polyethylene, polypropylene, polyvinyl chloride, and polystyrene.

14. The container of claim 1, wherein the body is constructed from a material selected from the group consisting of plastic, glass, and composite materials.

15. The container of claim 1, wherein the projections at the bottom end are coated with a non-slip material to enhance stability on smooth surfaces.

16. The container of claim 1, wherein the body is transparent or translucent to allow visual inspection of the contents.

17. The container of claim 1, wherein the body is opaque to protect the contents from light exposure.

18. The container of claim 1, further comprising an anti-tamper seal integrated with the closeable opening.

19. The container of claim 1, wherein the closeable opening comprises a snap-fit cap mechanism, a flip-top cap mechanism, a press-and-turn cap mechanism, or a hermetically sealed cap to ensure airtight storage.

20. The container of claim 1, wherein the body further comprises a grip-enhancing texture or coating on at least a portion of the surfaces.
